(19) United States
(12) Patent Application Publication
(10) Pub. No.: US 2005/0203924 A1
(43) Pub. Date: Sep. 15, 2005

(54) System and methods for analytic research and literate reporting of authoritative document collections

(76) Inventor: Gerald B. Rosenberg, Hillsborough, CA (US)

Correspondence Address: GERALD B ROSENBERG;NEW TECH LAW, 285 HAMILTON AVE, SUITE 520, PALO ALTO, CA, 94301, US

(21) Appl. No.: 10/799,552

(22) Filed: Mar. 13, 2004

(51) Int. Cl. G06F 7/00

(52) U.S. Cl. 707/100

(57) ABSTRACT

A computerized research system operates over an authoritative document collection to facilitate user analysis and organized reporting of information gathered from the collection. The computerized research system includes database, analysis and organization, and reporting modules. The database stores an index of a document collection, wherein the index is constructed to identify the occurrence of and association between authoritative assertions existing within the documents of the document collection. The analysis module is coupleable to the database and responsive to user interaction to provide a user navigable representation of authoritative assertions and to organize a user determined set of authoritative assertions selected from the document collection. The reporting module is, in turn, responsive to the user determined set to, under user direction, generate a report document containing a literate reporting of the user determined set of authoritative assertions.

### BACKGROUND OF THE INVENTION

1. Field of the Invention

The present invention is generally related to knowledge management and information retrieval systems and, in particular, to a comprehensive framework supporting the systematic acquisition, organization, evaluation, and presentation of authoritatively organized information, including authoritative knowledge.

2. Description of the Related Art

Contemporary document collections contain a wealth of information that, if properly organized and accessible, represents a substantial intellectual and commercial value. The many different scientific and legal document collections are of particular value, both in terms of practical, immediate application as well as facilitating advancement of fundamental scientific and social research. While this value has been long recognized, conventional efforts to use document collections as knowledge bases has been constrained by the unstructured semantic content of the document collections. Even where useful information is retrieved, there remain significant practical difficulties in enabling researchers to properly analyze and assimilate the information and then cogently present the knowledge to others.

Various knowledge management (KM) and information retrieval (IR) systems have been devised to improve upon the effective utilization, or functional performance; of document collections. Such systems are conventionally concerned almost exclusively with query production, corpus access and result ranking. While the desired operating paradigm is to process a question and receive an answer, conventional systems typically accept only structured or stylistically affected queries and return result sets consisting of a linear lists of documents that presumptively contain acceptable answers. To improve the performance of document collections, by increasing the peak and overall relevance of returned result sets, knowledge management and information retrieval systems have evolved a number of distinctive approaches for dealing with the inherently semantic representation of knowledge within the document collections.

While, as a formal matter, there is no definitive dividing line between knowledge management and information retrieval systems, systems implementing a knowledge management methodology typically utilize a manually established or possibly precalculated ontology to organize a document collection in anticipation of processing queries. Ontological categorizations are typically constructed to represent the discrete conceptual content of particular document collections. Subsequent user queries, constrained to one or more discrete categories, are thereby likely to return more relevant result sets provided the categories reasonably reflect the conceptual content relevant to the user.

While knowledge management systems can generally support a well correlated retrieval of documents relevant to the terms specified in a user query, there are several rather substantial limitations to such systems. One is that the practical utility of categorization is inherently limited to the relevant focus and level of detail existent in the ontological categories preestablished for the document collection. Another is achieving a meaningful level of accuracy in classifying documents into the predefined categories. Conventionally, expert personnel are required to read and classify each document added to the document collection. Indeed, multiple readings of each document may be required to ensure consistency and accuracy in the categorization process. Further readings may be required where, depending on the evolving content of the document collection, the ontology is revised or expanded. For example, West, now part of Thompson West™, began perhaps the first legal classification ontology in 1873. With a progressive expansion to now over 80,000 discrete categories, the West KeyCite™ ontology exists as the core of one of the largest manually maintained knowledge management systems. Adding on the order of 50,000 documents to the categorized collection each year, and allowing for the recategorization of documents following from ontological refinements, the time, expense, and quality control difficulties of maintaining this system are self-evidently extreme.

Various automated document classification schemes have been proposed. For example, the classification system described in U.S. Pat. 5,794,236 (Mehrle) provides for the autonomous classification of legal documents into a predefined legal classification hierarchy. Each legal document added to the collection is processed to extract and normalize, as necessary, the formal citations contained in the document. The normalized citations are then matched to pre-existing or manually established seed citations assigned to the various classification hierarchy levels. On seed citation matches, the legal document is annotated with the corresponding classification key for the matched seed citation. Subsequent, user-driven searches against the classification keys can then retrieve the applicable legal documents. However, legal and, similarly, scientific citation practices may cite a document for any number of different reasons, including entirely contradictory and contextually disjunctive reasons, which inherently reduces the effectiveness of purely citation-based user searches. Consequently, automated categorization systems, particularly those based on citation matching, have failed to demonstrate an adequate practical ability to distinguish classifiable information.

Other, mostly academic efforts to use automation to build categorical indexes focus on using data-mining techniques to discern concept-relations within the text of documents. Generalized heuristic systems, typically employing neural-network based architectures, are used to screen entire documents for concept-relations. Possible relations, identified in imprecise terms of graded significance, are in turn used to associate specific documents with various categories of an ontological categorization. In some systems, newly identified concept-relations, otherwise insufficiently related to existing categories, are presumed to self-define distinct categorical concepts and are then incorporated to extend the ontology index. For example, U.S. Pat. No. 6,502,081 (Wiltshire, Jr. et al.) utilizes an autonomous expert system to parse documents, discriminate presumptively meaningful concepts, and then assign the documents to appropriate levels within a classification hierarchy. The system relies on expert training, including a topic scheme representing an established ontology and a key-phrase list whose established terms ostensibly identify meaningful concepts specific to the source document collection. Term matches are then used to categorize each considered document. Term frequency and other presumed indicators of relevancy are also incorporated into the expert training as a further basis for discriminating concepts occurring in source documents, which in turn supports expansion of the usable classification hierarchy. Unfortunately, the extreme variety in semantic representations of discretely meaningful concepts, particularly as a document collection scales, makes such an automated classification all but unreliable.

Information retrieval, in contrast to knowledge management, typically deals with the evaluation, extraction and organization of knowledge directly from a generic information domain. Rather than pre-categorizing documents of a collection into an established ontology, information retrieval systems are employed to advantage where anticipating the nature of a query, and therefore any pre-construction of an ontology, is at least implicitly inappropriate or impractical. Instead, information retrieval systems primarily utilize a preprocessing of a document collection to produce a corpus index as a means of improving the speed of subsequent queries. In some information retrieval systems, the preprocessing is also used to derive an additional weighted basis for ranking potential search result sets. Information retrieval preprocessing is, however, usually constrained to preclude any substantive loss of content from the prepared corpus index.

Perhaps the most common form of information retrieval system employs text-based searches conducted against the full content of a selected document collection. Conventionally, the selected document collection is treated as a single corpus searched for matches against a user provided query set of word terms. The locations of matched terms identify potentially relevant documents within the corpus. The set of identified documents ranking above a minimum relevancy threshold, based on some calculation of matched term frequency of occurrence, term distribution, and term uniqueness within the documents, constitutes the query result set of relevant documents. Typically, the result set of relevant documents, ordered by weighted relevancy calculation rankings, are then simply presented to a user as a linear list of documents. Further determining the actual relevancy of the found documents, if any, is an activity beyond the scope of conventional information retrieval systems.

While generally able to identify potentially relevant information within even large, heterogeneous document collections, conventional information retrieval systems have a number of practical limitations. Perhaps the principle limitation is the presumed correlation of the collection metrics, by which any particular document is determined relevant, with the particular concept or information set intended by the user to be defined by the presented query set of search terms. Conventionally used metrics, such as inverse document frequency of terms, term uniqueness, and relative distance between term occurrences, inherently fail to represent semantic content, but rather represent only broad empirical associations of particular documents to possibly relevant information sets. These metrics, at best, define probabilistic relationships with indeterminate error. In practice, conventional relevancy metrics provide only a fair basis for ranking occurrences of the query terminology by document within the corpus.

Information that cannot or is not consistently defined in distinctive terms, often occurring where a semantic nomenclature applicable to a concept is itself variable or indistinct, will be even less likely to be reliably identified and retrieved by an information retrieval system regardless of the presented query term set. Any appropriate handling, empirical or otherwise, of vocabulary mismatches is generally beyond the ability of information retrieval systems. This problem is further compounded by any express vocabulary mismatch between whatever query terminology is incidentally provided by a user and the actual terminology used in the document collection, particularly where multiple distinct nomenclatures exist in the document collection for the same concept or concepts. Unfortunately, even where a single overall vocabulary is well adopted, any asystematic synomic variation in the terms as actually used in specific documents of the document collection will nonetheless directly impair the effective relevance of a query result set.

U.S. Pat. No. 5,696,962 (Kupiec) recognizes and demonstrates one approach for generically minimizing, at least in part, the vocabulary mismatch problem by automatically generating multiple alternatives for a given user query. The system described attempts to develop an optimized query specification by generating a range of alternate query term sets, each derived from the user provided query specification. These autonomously derived query sets are produced by applying various proximity and boolean qualifications to selected sub-combinations of the originally provided terms. The collection of broadened and narrowed query term sets are then issued as parallel queries. The individual search result sets then analyzed using differential criteria to identify the return set with the greatest group relevance.

A highly consistent result set, however, does not necessarily accurately or efficiently identify the documents that contain the information originally requested. That is, while an optimizing process may produce a consistent search result set, by in effect weighting the mutual relevance of the search terms, the ultimate quality of the search results are still fundamentally constrained to the limits of the relevancy metrics and vocabulary match between the original search terms and the document collection. Variances in terminology outside of the scope of the original query search terms, and thus the concepts represented thereby, are unlikely to be matched and thereby unlikely to be represented in the query result set.

Another, somewhat more practical problem for conventional information retrieval systems is maintaining adequate query performance against growing document collections. To accelerate search result production against typically large document collections, extensive pre-parsed word and phrase term indexes are used as the actual search corpus. The generation of such indexes, however, is itself computationally intensive and the generated indexes, containing multiple permutations of potentially relevant search term words and phrases, each further identifying a document location of occurrence, are often many multiples of the document collection size. Even where the indexes are constrained to word and phrase terms statistically selected based on likely semantic content, distinctive usage, and other language based cues, the resulting indexes are time and computationally intensive to generate. Furthermore, substantial portions if not the entirety of a corpus index must be recomputed whenever documents are added to the underlying document collection.

One conventional approach to improving the performance of full text content information retrieval systems is described in U.S. Pat. No. 5,819,260 (Lu et al.). To reduce the computational complexity of generating corpus indexes, and to reduce the size of the generated indexes, phrase terms are selected based only on the term frequency of occurrence, rather than on any analysis of semantic significance. Candidate phrase terms are partitioned based on a variety of basic syntactic rules referencing predefined features of the document text, such as certain punctuation, and a choice of the maximum number of words making up any phrase. These candidate phrases are then evaluated to identify those having the highest frequency of occurrence, which are then treated as significant discrete phrases presumptively representing significant conceptual content. Proper names are identified by rote rules and treated similarly as significant discrete phrases. The resulting, relatively limited number of high-frequency and proper name phrases are then compiled into corpus indexes. Although a substantial portion of the document collection content is thereby rendered unsearchable, the computational requirements needed to produce corpus indexes are reduced, permitting faster regeneration of the indexes to accommodate the addition of content, and the generated indexes are smaller, permitting improved indexed query performance.

Unfortunately, the presumed correlation between meaningful information content and the word and phrase terms carefully selected by the Lu et al. and other similar systems is poorly established. Conventional syntax, grammar, linguistic and even semantic analysis systems have generally not proven reliable in uniformly distinguishing worthwhile conceptual content generically occurring within a document collection of appreciable size and generality. Efforts to intelligently optimize corpus indexes have therefore largely failed to produce significant improvement in query results without incurring a substantive loss of searchable content and, therefore, compromising the desired precision obtainable for many different search queries.

Even where an ontology category or query result set capably identifies documents of relevance to a particular search topic, there remain fundamental, practical problems in exploring and establishing a useful understanding of the result set identified documents. Conventional knowledge management and information retrieval systems typically operate as query processor tools that ultimately produce, at best, relevance ranked lists of result set identified documents. A typical query processor provides a user interface for query text entry, a text search engine with access to an underlying corpus for evaluation of the query, and a simple presentation screen to display the literal results of the query. While some query processors provide aids to the development of query texts, such as by accepting relevance feedback based on prior query results as a query term, little support is provided for managing, organizing and evaluating result set identified documents. Often, what management support is provided is limited to allowing a user to name and save query specifications and particular sets of search identified document.

Various discrete approaches to the interrelated problems of organizing and evaluating search results have been developed. One common approach has been to develop network relational tools that enable navigation of a document collection based on some fixed, mutually relatable attribute contained in the documents. Bibliographic attributes, specifically, document citations, titles, and authors, have been used as a concrete basis for establishing document interrelationships. For example, U.S. Pat. No. 6,289,342 (Lawrence et al.) describes a citation indexing system that provides a document presentation interface navigable by citation hyper-links. A heuristics-based parsing system allows formal bibliographic citations, typically within document endnotes, to be found and matched to construct a network database. Once a conventional information retrieval search has identified a potentially relevant document, a display of the document permits user navigation, by clicking on a hyper-linked bibliographic citation, to another citation identified document.

As shown in U.S. Pat. No. 5,870,770, visual aids to the citation hierarchy, essentially a second level listing of citations, can be provided to assist in conceptualization of the navigable citation network and, as shown in U.S. Pat. No. 6,370,551, provide a limited context for the citation reference. In the former, the listing of citations is simply a listing of the citations related through the citation network to a specified citation in the current document. In the latter, a conventional information retrieval search is implicitly performed using the text in the current context to refine the selection of probabilistically related documents within the current document result set. In both, the precision of the document result sets are limited to the resolution of the citation, which is typically to an entire document, or at best to an entire page of text. In either case, the number of query terms in the refinement search is large and therefore of limited value. Consequently, conventional tools intended to facilitate organization and evaluation of document result sets have failed to prove particularly useful.

There is therefore a need for more comprehensive and capable knowledge management and information retrieval systems and tools for supporting management, organization and evaluation of the document result sets, particularly when involving complex document collections, such as those utilized in the hard science and legal disciplines.

### SUMMARY OF THE INVENTION

Thus, a general purpose of the present invention is to provide a comprehensive system and tools for performing directed knowledge management and information retrieval searches against complex document collections particularly including those containing authoritatively organized information.

This is achieved in the present invention by establishing a computerized research system that operates over an authoritative document collection to facilitate user analysis and organized reporting of information gathered from the collection. The computerized research system includes a database, an analysis module, and a reporting module. The database stores an index of a document collection, wherein the index is constructed to identify the occurrence of and association between authoritative assertions existing within the documents of the document collection. The analysis module is coupleable to the database and responsive to user interaction to provide a user navigable representation of authoritative assertions and to organize a user determined set of authoritative assertions selected from the document collection. The reporting module is, in turn, responsive to the user determined set to, under user direction, generate a report document containing a literate reporting of the user determined set of authoritative assertions.

An advantage of the present invention is that the system provides a comprehensive information research solution, capable of supporting directed information retrieval, organization and evaluation of document result sets. The preferred system incorporates a complete, interactive framework for information retrieval, including systematically managing the acquisition, organization, evaluation, and presentation of information from document collections. Multiple search session methodologies can be used to initially establish document result sets. A search session may be directed initially by a full text search, or selection of a search entry point from a given document or category entry in an existing collection ontology. Once at least initial results for a search session are obtained, the result set is organized and managed to support guided navigation over and the selection and literate reporting of relevant information.

Another advantage of the present invention is that the system utilizes a contextual network of authoritative statements, establishing assertions, as a basis for developing document search result sets and, in particular, to support navigation and organization of the search results to facilitate evaluation and selection of conceptually relevant information. Autonomous correlation of authoritative statements permits nominative identification of contextually significant authoritative information within a document collection with a high degree of accuracy. The framework permits searches and result set navigation based on the network of correlated authoritative assertions identified as existing within the search targeted portion of the document collection. Graphical and text-based views of correlated authoritative assertions are preferably used to facilitate navigation and selection of relevant information.

A further advantage of the present invention is that the location of contextually significant assertions are resolved effectively to a sentence structure level. Through a correlation of available citation references, the precision of authoritative statements can be specifically established, permitting an actually cited authoritative assertion and correlated variations to be discretely resolved and ranked. The establishment of correlated authoritative assertions enables construction of a robust, consistent, and substantively oriented navigable network of authoritative statements and associated semantically significant document content. Relative weighting of correlated assertion variants reflects the significance of particular formulations of the authorities and, further, facilitates clustering of correlated authoritative statements and association of clusters of related authoritative assertions. Additional weightings can be associated to reflect the relative occurrence, proximity, and ordering of related authoritative statements. These weightings can be used particularly in the organization and evaluation of document search results to suggest, as reflecting, a conceptual ordering of the information returned as well as identifying possible semantic content groupings, nominally recognized as other topics and issues, not otherwise identified or recognized in an initial query result set.

Still another advantage of the present invention is that authoritative statements determined as relevant through user review of document result sets can be ultimately accumulated into a literate search report. The authoritative statements, as discrete literate formulations of relevant information, are collected and ordered, by default, based on the mutually related weightings. Manually specified order modifications, edits of the authoritative statement text, and other provided text are regenerable into a structured document. These user provided modifications, whether in the form of text or organization, are maintained in effect as a template through subsequent regenerations of the literate report, thereby permitting user search reports to be freely modified, the search and authoritative statement analysis continued, and production of new versions of the literate reports without loss of either the automated or user contributions.

Yet another advantage of the present invention is that individual search query specifications and result sets can be saved for subsequent reference and use. Furthermore, result sets can be directly created and recovered from existing documents, including literate search reports previously produced by the system. This re-entrant capture of search report sets from existing literate documents reports in turn permits reexamination, verification and analysis of authoritative citations, and possible augmentation presented in a literate report document, while preserving any externally provided contribution. In the some manner, independently created documents can be analyzed against an evaluation of the authoritative statements existing in the document.

Still another advantage of the present invention is that clustering analysis, based on the correlated authoritative statement weightings, enables inferential derivation and development of a knowledge ontology for the document collection. Citation references are utilized to develop correlated weightings to identify clusters, the relative importance of individual authorities within clusters, and the significant relationships between topics inferentially identified by clusters. The knowledge ontology produced by cluster analysis can be used to further identify potentially related topics as well as infer a categorically ordered analytic sequence specific to closely related topics.

A yet further advantage of the present invention is that a research issue library, maintained as an organized set of research result sets, can be generated and maintained by the computerized system implementing the present invention. Individual authorities can be matched against the library sets to immediately select and being interactive navigation and evaluation of applicable document result sets, leading to the generation of customized literate report documents.

These and other advantages and features of the present invention will become better understood upon consideration of the following detailed description of the invention when considered in connection with the accompanying drawings, in which like reference numerals designate like parts throughout the figures thereof.

### BRIEF DESCRIPTION OF THE DRAWINGS

FIG. 1 is a block diagram illustrating a research framework as provided in a preferred embodiment of the present invention;

FIG. 2 is a general view of a multi-tier distributed operating environment for a preferred embodiment of the present invention;

FIG. 3 illustrates the system and process, for a preferred embodiment of the present invention, of rendering source documents of a document collection into an operable document data resource for use within the research framework;

FIG. 4 provides a block diagram of a user directed module of the research framework as constructed in accordance with a preferred embodiment of the present invention;

FIG. 5 provides a flow diagram illustrating the research process enabled and data transformation operations implemented in accordance with a preferred embodiment of the present invention;

FIG. 6 illustrates the system and process of operating, for a preferred embodiment of the present invention, the user directed search and presentation subsystems as provided in a preferred embodiment of the present invention;

FIG. 7 provides a graphical representation of an assertion cluster view demonstrating the attributed and weighted relationships between authoritative assertions associated with a citation in accordance with a preferred embodiment of the present invention;

FIG. 8 provides a graphical representation of a citation relationships view demonstrating the attributed and weighted relationships between correlated authoritative statements in accordance with a preferred embodiment of the present invention; and

FIG. 9 illustrates the system and process of operating, for a preferred embodiment of the present invention, the user directed composition subsystem as provided in a preferred embodiment of the present invention.

### DETAILED DESCRIPTION OF THE INVENTION

The present invention provides a cohesive system or framework for efficiently performing information research against the typically complex document collections that utilize authoritative citations to internally organize and substantiate the information represented by the collection. Such authoritative document collections, including as exemplary the various scientific and legal document collections, characteristically employ a consistent system of internal cross-references to and into other documents to establish authoritative support for assertions made and conclusions reached in a current document. In accordance with the present invention, utilization of the full information content of authoritative statements, defined for purposes of the present invention as including assertions and citations, enables the knowledge contained within a document collection to be efficiently and effectively accessed and utilized. Although citation networks have been used as a basis for exploring document collections, conventional citation references are not only ambiguous, but also lack semantic content. As recognized in the present invention, the construction of a analytic network based on the relational association of assertions is both fully resolvable and enables direct exploration of the significant semantic content of the underlying document collection.

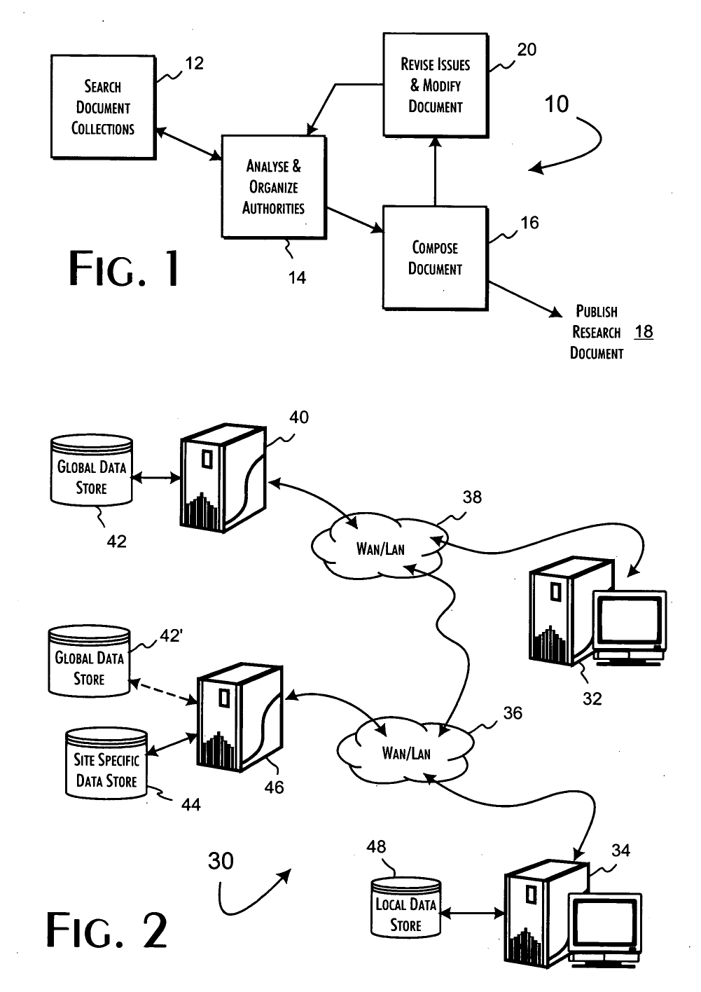

The document collection research framework provided by the present invention supports fundamental research operations, including search, analysis, organization and reporting. As generally shown in FIG. 1, the research framework 10 supports performance of information searches 12 interactively with analysis 14 of the resulting document result sets. Information searches, including additive and narrowing searches, can be performed using any of multiple methodologies to establish document result sets for analysis.

The analysis module 14 of the framework 10 supports evaluation and organization of document result sets to produce research sets that collect authoritative statements determined relevant to a research topic. The analysis utilizes correlated relationships between authoritative statements occurring within the documents of the result sets and between those documents and other documents within the document collection to facilitate both the identification and organization of further relevant authoritative statements. The mutual organization of authoritative statements, at least initially, is preferably derived autonomously from the ordered occurrence of the authoritative statements, as correlated, either within the documents collected into the research set or the document collection as a whole, or both. This order is subject to manual modification and generally maintained through any autonomous organization of subsequently added authoritative statements.

A report composition module 16 of the framework 10 can be invoked over a research set to generate a literate report of the corresponding authoritative statements. The composition of a literate report, at a minimum, provides for rendering the internal representation of a research set into a publishable research document 18. More complex composition processes can be used to conform the embedded citations into a publication normal form and to render the included assertions based on grammatical and linguistic processing to improve the literate composition of reports. Preferably, structured representations of the source and processed literate report are maintained through the composition process.

In support of the analysis, organization and composition operations, the framework enables revision processing 20 feedback. Utilizing internal or external editors, revision processing 20 permits user modification and additions to be made to the structured document representation. Modifications can be made directly by a user as well as indirectly through modification of the underlying research set. These modifications are maintained persistent through regeneration of a literate report based on a versioned correlation between the research set and the material added or modified.

A preferred general application of the present invention involves a server computer system, enabling access to an authoritative document collection, and client computer systems that interoperate with the server to direct searches and perform analysis and reporting. As illustrated in FIG. 2, however, the system architecture 30 of the present invention is equally, and more broadly, applicable to configurations involving staged or tiered document collections of varying scope of content and availability to different clients. Accordingly, exemplary local client computer systems 32, 34 access, through communications links, such as intranet 36 and internet 38 network connections, a document collection server 40 that hosts, directly or indirectly, a desired global document collection store 42. Preferably, an index of the contained authoritative statements, as produced through a preprocessing operation, is similarly hosted by the server 40.

The local client 32, as shown, relies on the server 40 to remotely implement the functions of the framework 10 as an application service provider. Local client 34 alternately implements the framework 10 through a client application that can access, as needed, the global document collection store 42, a site specific document collection store 44, through a site server 46, and a local document collection store 48, which may also be used by the local client 34 to persist document result sets, research sets, and reports. Other architectural variations can implement the framework 10 as a distributed application where, for example, select searching and navigation operations are implemented on the servers 40, 46, while principle analysis and report generation operations are executed local to the client computer system 34. Particularly in the later instance, many of the functional operations of the framework 10 can be implemented as web-services by the server 40 which can then be unitized by a client application executing on the client 34.

The hosting of document collections by site server 46 potentially permits improved performance by enabling intranet 36 access to a site local copy 42′ of the global document collection store 42. Support for other site local document collections 44 permit proprietary documents to be securely maintained internal to the site and accessible to clients within the site subject to site specific security controls. In similar fashion, client proprietary documents can be maintained in a local document collection store 48 further subject to access controls defined by the particular client 34.

In preferred embodiments of the present invention, the basic search operation of the framework 10 is performed on the servers 40, 46, including the client 34, for the respectively hosted document collections 42, 42′, 44, 48. Although a single search term query may be issued, the return of multiple document result sets is not problematic. At a minimum, each result set can be independently evaluated and relevant authoritative statements merged into one or more research sets as desired by the user. Where documents in a lower tiered document collections cite documents in a higher tier, the referenced authoritative statements can be mutually correlated and navigated, permitting analysis directly as a merged document result set.

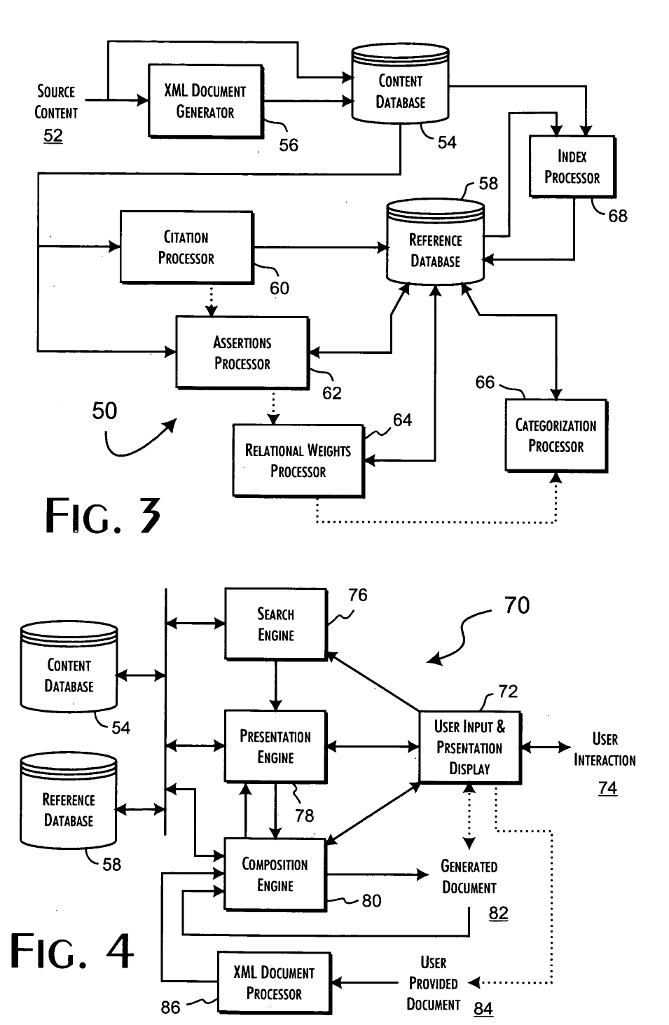

A preferred system 50 for preprocessing document collections is shown in FIG. 3. Source content 52, preferably electronic copies of the source documents of a chosen document collection, typically in portable document format (PDF), Postscript™ (PS), Microsoft® Word, Corel® WordPerfect, or similar format, are collected into a document content database 54 as direct copies or reliable indirect references to the source content 52. Each of the source content documents is also preferably processed through an XML document generator 56 that, based on a combination of analytic and heuristically evaluated rules, disambiguates the individual sentences of the document and, further, distinguishes the principle sections of the document. The section identifications and sentence boundaries are reflected in the structure of the corresponding XML document produced by the document generator 56. In the case of a scientific journal article, the sections distinguished preferably include a heading section, including the journal name, the formal article citation, and authors, an article body section, and typically an endnote section. For an appellate-type or similarly structured judicial opinion, a heading section preferably includes the case style, participating parties, formal case citation, representing attorneys, and judicial panel. Body sections are defined for the majority opinion and, as applicable, any minority and dissenting opinions. Footnotes are preferably incorporated into the bode sections.

The content of each document, as processed through the XML document generator 56, is preferably incorporated into a corresponding XML document stored to the document content database 54. Disambiguated sentences are stored as elements within corresponding section defined portions of the XML document. Paragraph and other formating features, including quotes and image references, are also preferably recognized and recorded as particles in the XML document. For purposes of the present invention, such content and meta-data features can be further stored using a schema description consistent with the Resource Description Framework (RDF), a recommended specification of the W3C (REC-rdf-syntax-19990222).

The operative definition of a sentence boundary, nominally defined in terms of a standard grammatical sentence structure, may vary depending on the nature of the content of each section. For example, an author list or a case style, while not a sentence in conventional grammatical definition, is preferably recognized in the processing of the heading section of an article or case document as a sentence occurring within the corresponding section of the document. Each disambiguated sentence is preferably numbered within the XML document relative to the section in which the sentence occurs. The sentences can be numbered in a simple sequence or hierarchically relative to the occurrence of paragraphs within sections. Sections are preferably named. While an implicit numbering scheme may be used, explicit numbering recorded in the XML document is preferred to permit revisionary changes to be recognized and recorded for historical use and to potentially improve performance of the overall system.

The XML documents are further pre-processed to generate a reference database 58 storing form normalized citations, resolved preferably to a sentence level, correlated authoritative assertions, tables of weighted relations associating the correlated authoritative assertions, and an ontology preferably derived from the correlation of authoritative assertions. Initially, a citation processor 60 operates to locate citations within XML documents as stored in the content database 54. Citations may occur exclusively in an endnote section, as discrete sentences within a body or other sections of the document, or variously embedded in otherwise disambiguated sentences. Citation forms are preferably recognized and normalized to a defined standard based on analytic or heuristic rules evaluated by the citation processor 60. Preferably, the normalized form represents a full formal specification of the citation. Partial or abbreviated citation forms and relative citation forms, such as Id. and Supra, are resolved to full form citations by referring back through the document until citation ambiguities are resolved. The full form citations, including the document locations of the citations, are recorded in the reference database 58.

An assertions processor 62 performs a more extensive evaluation of the content database 54 XML documents to identify authoritative assertions using semantic and grammatical analysis. For purposes of the present invention, an authoritative assertion is defined as a statement made to impliedly establish a concept or contention as fact, typically supported by citation reference to a preexisting basis or line of reasoning, typically associated with a prior or precedential authoritative assertion, or statement of convention, such as a statute or definition. To identify authoritative assertions, a semantic analysis is performed against the disambiguated sentences to identify those likely to represent authoritative assertions. The present invention considers sentences occurring in close proximity to citations as being likely authoritative assertions. The locations of citations are determined directly from the citation processor 60, when operating in parallel, or determined in subsequent operation from the XML data produced and stored in the reference database 58 by the citation processor 60.

In the case of simple footnote and endnote citations, the note references directly associates citations with particular sentences and therefore identify corresponding authoritative assertions. In other circumstances, particularly in judicial opinions where for various reasons the association is less clear, grammatical and semantic analysis of the relation between a citation and the surrounding sentences and of the sentences themselves can be used to identify the authoritative assertion associated with a particular citation.

As an example, consider the following excerpt from a source legal opinion at paragraph 45 of the majority opinion: Section 1498(a) applies exclusively to patent law, meaning that Federal Circuit law applies. Nat'l Presto, 76 F.3d at 1188 n.2, 37 USPQ2d at 1686 n.2. One might counter-argue that § 1498(a) is procedural. However, to the extent that § 1498(a) is procedural, it is unique to patent law, which also indicates that Federal Circuit law applies. Id.

In accordance with a preferred embodiment of the present invention, pre-processing through the XML document generator 56, citation processor 60, and assertions processor 62 yields the partial representation of the corresponding XML document data listed in Table I, which is stored to the reference database 58. This exemplary representation demonstrates selective identification of assertions, association of assertions with citations, generic grammatical normalization of the assertions, and citation normalization:

TABLE I

```
<Section=”majority”>
  <AuthStmt>
    <Location>45,1</Location>
    <Assert>Section 1498(a) applies exclusively to patent law,
      meaning that Federal Circuit law applies. </Assert>
    <Cite>Nat'l Presto v. W. Bend Co., 76 F.3d 1185, 1188 n.2
      (Fed. Cir. 1996) </Cite>
    <Cite>Nat'l Presto v. W. Bend Co., 37 USPQ2d 1685, 1686
      n.2 (Fed. Cir. 1996) </Cite>
    <Cite>28 U.S.C. §1498(a)</Cite>
  </AuthStmt>
  <AuthStmt>
    <Location>45,2</Location>
    <Assert>One might counter-argue that § 1498(a) is
      procedural. </Assert>
    <Cite>28 U.S.C. §1498(a)</Cite>
  </AuthStmt>
  <AuthStmt>
    <Location>45,3</Location>
    <Assert>to the extent that § 1498(a) is procedural, it is unique
      to patent law, which also indicates that Federal Circuit
      law applies. </Assert>
    <Cite>Nat'l Presto v. W. Bend Co., 76 F.3d 1185, 1188 n.2
      (Fed. Cir. 1996) </Cite>
    <Cite>Nat'l Presto v. W. Bend Co., 37 USPQ2d 1685, 1686
      n.2 (Fed. Cir. 1996) </Cite>
    <Cite>28 U.S.C. §1498(a)</Cite>
  </AuthStmt>
</Section=”majority”>
```

Similarly, consider the following source legal opinion excerpt, occurring at paragraph 63 of the majority opinion: In order to succeed on its claims of inducement of infringement and contributory infringement, Anton/Bauer must prove that its own customers directly infringe the '204 patent when they use PAG's accused PAG L75 battery pack in combination with its female plate. See Carborundum Co. v. Molten Metal Equip. Innovations, Inc., 72 F, 3d 872, 876 n.4, 37 USPQ2d 1169, 1177 n.4 (Fed. Cir. 1995) (“Absent direct infringement of the claims of a patent, there can be neither contributory infringement nor inducement of infringement.”). Accordingly, we must determine whether Anton/Bauer's customers directly infringe the '204 patent.

This excerpt is preferably pre-processed to normalize and associate multiple assertions with a single normal form citation, as shown in Table II, which association is determined in this case as appropriate based on the grammatical relationship established by the recognized linking term, “See,” and by the convention of the appended parenthetical, generally as follows:

TABLE II

```
<Section=”body”>
  <AuthStmt>
    <Location>63,1</Location>
    <Assert>In order to succeed on its claims of inducement of
      infringement and contributory infringement,
      Anton/Bauer {plaintiff} must prove that its own
      customers directly infringe the patent when they use
      PAG's {defendant} accused PAG {defendant} L75
      battery pack in combination with its female plate.
      </Assert>
    <Cite>Carborundum Co. v. Molten Metal Equip. Innovations,
      Inc., 72 F.3d 872, 876 n.4, (Fed. Cir. 1995) </Cite>
    <Cite>Carborundum Co. v. Molten Metal Equip. Innovations,
      Inc., 37 USPQ2d 1169, 1177 n.4 (Fed. Cir. 1995)
      </Cite>
  </AuthStmt>
  <AuthStmt>
    <Location>63,3</Location>
    <Assert>“Absent direct infringement of the claims of a patent,
      there can be neither contributory infringement nor
      inducement of infringement.” </Assert>
    <Cite>Carborundum Co. v. Molten Metal Equip. Innovations,
      Inc., 72 F.3d 872, 876 n.4, (Fed. Cir. 1995) </Cite>
    <Cite>Carborundum Co. v. Molten Metal Equip. Innovations,
      Inc., 37 USPQ2d 1169, 1177 n.4 (Fed. Cir. 1995)
      </Cite>
  </AuthStmt>
</Section=”body”>
```

The foregoing examples are meant to provide an exemplary representation of the preferred XML schema structure used in the storage of data to the reference database 58. Where more complex relationships between authoritative assertions and citations exist in a particular document collection, a deeper, more complex XML schema organization may be utilized.

Statutes and established definitions, such as dictionaries and “the third law of thermodynamics,” are preferably treated as citations for purposes of identifying corresponding authoritative assertions. While most authoritative assertions will ultimately be identifiable from an associated citation or by reference from another authoritative statement, a few unassociated assertions will occur in new documents and others may persist unrecognized in existing documents. Preferably, disambiguated sentences otherwise unassociated with citations are heuristically analyzed to identify those that are statistically likely to represent authoritative assertions. These presumed authoritative assertions are associated with a citation to the corresponding document of occurrence, marked as tentative authoritative statements, and stored in the reference database 58.

The relational weights processor 64 operates over the XML data stored in the reference database 58 to compute metrics reflecting associative relationships between the authoritative assertions that occur in the document collection. These relationships are preferably classed as cluster, reference, and co-occurrence associations. Cluster associations represent the correlated similarity between multiple different authoritative assertions associated with the same or equivalent citations and the correlated similarity between a given authoritative assertion associated with multiple different citations. Reference associations represent the correlated associativity between authoritative assertions based on citation references linking one authoritative assertion to another. Co-occurrence associations represent the correlated associativity between authoritative assertions based on mutual co-occurrence of the authoritative assertions within documents, including the effective order and distance of occurrence relationships between authoritative statements. Other relationship associations may also be determined.

To determine correlated similarity between assertions, the relational weights processor 64 preferably implements a semantic content metric for evaluating the substantive similarity of authoritative assertions. The metric preferably provides a basis for performing a semantic comparison by generating a similarity basis value for each assertion dependent on the hierarchical relatedness of the stemmed word content of each of the authoritative assertions. The semantic comparison metric preferably uses part-of-speech tagging as a further basis to establish comparability.

Based on a statistical analysis of correlated similarity, cluster associations are identified principally on the basis of groups of similar authoritative assertions associated with the same or equivalent citation. Since the normal form of a citation is specific only to a page level, multiple independent assertion clusters may be associated with a normal form citation. Each multiple cluster set thus serves to identify at least the precedential authoritative assertions identifiable by reference from the corresponding normal form citation.

Cluster associations are also identified for authoritative statements that include multiple, distinct authoritative citations associated with a single authoritative assertion. Cluster associations are based on a similarity metric that considers the set overlap of the citations and the semantic similarity of the authoritative assertions.

Preferably, for each established cluster, a normal form authoritative assertion is preferably identified as a generic representative of the cluster. This normalized assertion can be an existing assertion identified as having an assertion similarity value that is close to the correlated mean assertion similarity value of the cluster. Alternately, a synthetic assertion can be generated as a representative composite of the clustered assertions and that further has the correlated mean assertion similarity value of the cluster. Data describing each cluster is then stored to the reference database 58. This data preferably includes an identification of the clusters and cluster sets and, for each identified cluster, the cluster normalized assertion, values representing the correlated similarity between the individual clustered assertions and the normalized assertion, and the similarity basis value for each assertion.

The relational weights processor 64 further functions to identify and correlate reference associations between authoritative assertions. The principal form of a reference association is defined to exist between an authoritative statement and the authoritative assertion identified by the statement citation. Given that a nominally specified citation resolves only to a page level, the relational weights processor 64 preferably performs semantic similarity comparisons between the source assertion of an authoritative statement and the disambiguated sentences that occur on the page identified by statement citation. The sentence that most closely correlates to the source authoritative assertion is taken as the citation target and completes the reference association. Reference associations are also at least implicitly recognized as occurring between the assertion of an authoritative statement and the cluster associated with the citation target assertion and between the clusters associated with both the source and target assertions.

Data representing at least the principal reference associations are stored to the reference database 58. This data preferably identifies the authoritative assertions associated by reference, the associative direction of the reference, the associating citation, and the relative strength of the semantic similarity by which the association was determined. The associating citations are preferably further annotated to specify the sentence level location of the citation target sentence. Additional information can be generated to represent, based on statistical frequencies, the relative certainty of the sentence level identification of citation targets, the associativity of the source assertion to target assertion clusters, the associativity between the assertion clusters containing the source and target assertions, and the associativity of the source and target assertions based on the overlap in citations that occur in authoritative statements with the source and target assertions.

The relational weights processor 64 derives co-occurrence associations from the relative order of occurrence of authoritative assertions within the documents of the document collection. Weighted data is then generated to represent the effective order and distance of occurrence between authoritative assertions within the documents of the entire document collection. For any particular authoritative assertion, the generated relational weights data preferably represents, relative to the occurrences of the assertion in the documents of the collection, the affinity of the assertion to other assertions that Occur in the same documents, the ordered distance from the assertion to each of the other assertions that occur in current section of the document, and the affinity and ordered distance of the assertion to other assertions within a statistically localized cluster of co-occurring assertions identified within like sections of the documents of the collection.

For example, consider the following excerpt from a source legal opinion: The court gives plenary review to interpretation of the scope of patent claims and to the grant of summary judgment based thereon. See Cybor Corp. v. FAS Technologies, Inc., 138 F.3d 1448, 46 USPQ2d 1169 (Fed. Cir. 1998) (en banc) (claim construction is performed de novo on appeal). Summary judgment is warranted where “there is no genuine issue as to any material fact and the moving party is entitled to judgment as a matter of law. ” FED. R. CIV. P. 56®); Becton Dickinson and Co. v. C.R. Bard, Inc., 922 F.2d 792, 795 (Fed. Cir. 1990); Southwall Technologies, Inc. v. Cardinal IG Co. 54 F.3d 1570, 1575 (Fed. Cir. 1995). Material facts are those that might affect the lawsuit under the governing substantive law. Anderson v. Liberty Lobby, Inc. 477 U.S. 242,248 (1986). The court will draw all reasonable factual inferences in favor of the non-moving party. Id. “For the grant of summary judgment there must be no material fact in dispute, or no reasonable version of material fact upon which the nonmovant could prevail.” Brown v. 3M, 265 F.3d 1349, 1351 (Fed. Cir. 2001).

By operation of the citation, assertions, and relational weights processors 60, 62, 64, the authoritative statements are resolved to the information representationally presented in Table III, where Px and Sx/Sy are derived citation-target page and sentence numbers:

TABLE III

| Assertion | Cite | |
|---|---|---|
| 1 | The court gives plenary review to interpretation of the scope | |
| | of patent claims and to the grant of summary judgment based | |
| | thereon. | |
| | A | Cybor Corp. v. FAS Technologies, Inc., 138 F.3d |
| | | 1448 [at Px [Sx]] |
| 2 | Claim construction is performed de novo on appeal. | |
| | B | Cybor Corp. v. FAS Technologies. Inc., 138 F.3d |
| | | 1448 [at Px [Sx]] |
| 3 | Summary judgment is warranted where “there is no genuine | |
| | issue as to any material fact and the moving party is entitled to | |
| | judgment as a matter of law.” | |
| | C | FED. R. CIV. P. 56 ©) [[Sx]] |
| | D | Becton Dickinson and Co. v. C. R. Bard, Inc., 922 |
| | | F.2d 792, 795 [[Sx]] |
| | E | Southwall Technologies, Inc. v. Cardinal IG Co., 54 |
| | | F.3d 1570, 1575 [[Sx]] |
| 4 | Material facts are those that might affect the lawsuit under the | |
| | governing substantive law. | |
| | F | Anderson v. Liberty Lobby, Inc., 477 U.S. Pat. |
| | | No. 242,248 [[Sx]] |
| 5 | The court will draw all reasonable factual inferences in favor | |
| | of the non-moving party. | |
| | G | Anderson v. Liberty Lobby, Inc., 477 U.S. Pat. |
| | | No. 242,248 [[Sy]] |
| 6 | “For the grant of summary judgment there must be no material | |
| | fact in dispute, or no reasonable version of material fact upon | |
| | which the nonmovant could prevail.” | |
| | H | Brown v. 3M, 265 F.3d 1349, 1351 [[Sx]] |

For a preferred embodiment of the present invention, relative to an ememplary authoritative statement 4F, the relational weights processor 64 preferably derives, in part, the information presented in Table IV (the given cluster identifiers, affinity values, and weights are nominative, for purposes of illustration) for a given sample text. The data stored to the reference database 58 is aggregated to represent all occurrences of the authoritative assertions.

TABLE IV

| | Target | Cluster | Cluster | Stmt | Local | Ordered |
|---|---|---|---|---|---|---|
| Auth Stmt | Stmt | ID | Affinity | Affinity | Affinity | Distance |
| | 1A | | — | 66 | 25 | −3.0 |
| | 2B | | — | 61 | 27 | −2.0 |
| | 3C | | — | 87 | 72 | −1.0 |
| | 3D | | — | 93 | 72 | −1.1 |
| | 3E | | — | 84 | 72 | −1.2 |
| 4F | 4F | IV | 84 | 100 | — | 0.0 |
| | 5G | | — | 87 | 79 | +1.0 |
| | 6H | | — | 95 | 87 | +2.0 |

The cluster identifier specifies the cluster association determined from the assertion identified for the authoritative statement 4F. The cluster affinity value represents the semantic content metric calculated for an assertion (4F) relative to the association cluster mean. The statement affinity value is a co-occurrence frequency term, preferably computed as an aggregate weighted strength of co-occurrence of the target authoritative assertions. The local-cluster affinity similarly represents the strength of co-occurrence, though weighted relative to the local statistically distinguishable co-occurrence cluster of the assertions. The ordered distance metric provides a weighted value reflecting the statistically representative distance and direction between co-occurrences of the authoritative assertions.

In accordance with the present invention, each local cluster or closely affine group of clusters, is considered to likely represent a relatively discrete issue or interrelated sequence of issues. In aggregate for the document collection, the relational weight information, particularly relative to localized co-occurrence clusters, can be presumed to reflect an evident natural ordering, including time-ordered precedence and mutual relevance, of these issues as addressed within the documents of the collection. In authoritative document collections that employ a highly structured approach to issue analysis, such as typical of the legal document collections, the relational weighting of co-occurrence can be used to inform the conventional presentation of a structured issue analysis.

As generated, the co-occurrence association relational weighting data is recorded to the reference database 58. Any other statistically significant association weightings generated by the relational weights processor 64 are also stored to the reference database 58.

A categorization processor 66 operates primarily from the identification of authoritative assertion clusters and the affine and weighted relations to derive an ontology representative of the underlying document collection. Preferably, a statistical analysis of the frequency and mutual affinity of particular assertions and associated clusters is used to distinguish significant clusters, including affine groups of clusters, that can be used, in turn, to represent hierarchically the various category levels of an ontology. The normal assertions of the clusters are preferably used to provide the reference descriptions of the various levels presented in the ontology listing.

An index processor 68 generates a number of indexes based on the information stored to the content and reference databases 54, 58. These indexes are stored, in the preferred embodiments of the present invention, to the reference database 58 as additional reference resources. A search index generated by the index processor 68 is preferably a full text index derived from the source content 52. This index is preferably based on stemmed, contextually significant word and phrase terms of the source content 52 and further includes conventional term significance metrics, such as inverse document frequency. A citation index stores location information for each citation identified within the document collection by the citation processor 60. Preferably, each distinct citation is stored in a normalized form further annotated to specify the disambiguated sentence-level location of the citation target assertion. An assertion index stores the disambiguated sentence-level location of each authoritative assertion within the document collection, as determined by the assertion processor 62, the cluster associations of the assertion, and the cluster normalized form of the assertion. The various affine and weighting values interrelating assertions, relating assertions to clusters, and interrelating clusters as generated by the relational weights processor 64 are indexed as appropriate to permit rapid retrieval by reference to any particular assertion or cluster. An ontology index provides rapid access to the document collection ontology determined by the categorization processor 66.

A user directed module 70 of the research framework 10, as shown in FIG. 4, utilizes the data contained in the content and reference databases 54, 58, to support the interactive framework functions of collection search and research analysis, organization and generation of literate research reports. A user input and display module 72 supports user interaction 74 including the receipt of user input, textual and graphical presentation of data, and, optionally, import and editing of literate report and other documents. Preferably, the user input and display module 72 provides for the presentation of a search query input screen, permitting the specification of search terms and phrases, as well as a selectable list representing the document collection ontology produced by the categorization processor 66. The user input and display module 72 also presents other textual and graphical representations of document collection analysis operations that further permit direct or indirect specification of search queries.

Search oriented user input information, including search query texts, ontology selections, and explicit citations, are provided to a search engine 76. The search engine 76 preferably implements an information retrieval-type search operation active over the text indexed document collection. Constraints, such as to the publication journal, publication date range, and the like, are accepted as meta-search terms. A specific ontology category selection is preferably expanded by the search engine 76, by access to corresponding indexes, to references to corresponding assertions, and to the documents that contain the assertions. Similarly, a reference to a cluster or assertion made through user interaction 74 with respect to a presented list or graphical presentation, is applied to the search engine 76 as a reinforcing search selection. The effective product of the search engine 76 is one or more document result sets, each referencing the documents selected through some combination of an information retrieval search and a search for one or more authoritative assertions identified to the search engine 76.

Document result sets produced by the search engine 76 are provided to a presentation engine 78. In a preferred embodiment of the present invention, the presentation engine 78 operates to produce one or more graphics and text-based navigable representations of the assertions presented in the document result sets or as selected for inclusion in one or more assertion research sets. In the graphical views, node networks are used to graphically represent the relationship between assertions, with individual nodes representing, as applicable, authoritative assertions and assertion clusters, and node connectors detailing the nature of the relationship based, for example, on line attributes, including text references, length, style, thickness, and color. Preferably, simple navigation operations, such as hovering the cursor over a node or connector or variously selecting a node or connector, presents various levels of textual annotation describing the node or connector selected, as pop-ups and in ancillary views, and controls for further navigating the node network, such as to expand a cluster into a node network of distinct constituent assertions, either directly or through an additional view. Preferably, the controls also enable selected assertions to be added to a new or existing research set.

In a preferred embodiment of the present invention, a research set is nominally represented by the presentation engine 78 as both a viewable text listing of the assertions referenced by the research set and a node network view of the same assertions, collectively a research view set. Through the user input and display module 72, which provides for the display of the lists and views for user interaction 74, assertions can be selected from other views and lists for inclusion in a particular research set. Absent a specific user interaction 74 to specify the insertion point of an added assertion in the research set, the presentation engine 78 autonomously determines a likely preferred ordering based on an evaluation of the affine, weight, and ordering relations data stored by the reference database 58 for the selected and existing assertions. Where an insertion point is interactively specified, the assertion is added in the location identified. User interaction 74 can also provide for the deletion of assertions and the reordering of assertions existing in the research set. In each case, the research view set is automatically updated by the presentation engine 76 to reflect the modification and the results displayed via the user input and display module 72. Preferably, possible additions, omissions and mis-orderings, determined autonomously based on an evaluation of the relations data, are displayed with distinctive attributes as part of the research view set.

A research set can be selected and passed to a composition engine 80 at any time in response to user interaction 74. Preferably, the composition engine 80 generates an XML document 82 that contains the assertion statements, including both the authoritative assertion and associated citation, referenced by the research set in the order presented in the research set. Other document formats can be produced either by filtering from an initially generated XML document 82 or directly generated. An XML or other structured document format is preferred to facilitate the later reprocessing of the generated document 82 by the composition engine 80.

In a preferred embodiment of the present invention, the generation of the document 82 further performs a grammatical, including syntactic, processing of the assertion text referenced by the research set to improve the literate presentation of the sequence of authoritative statements. In addition to grammatical correction based on an evaluation of the assertions directly, the composition engine 80 preferably accesses the content database 54 to examine occurrences of the assertions effectively in the original context of the source content documents 52. Particularly where successive assertions are collocated, and generally where the assertions occur in close proximity, the original presentation may be used to inform the grammatical processing operation of the composition engine 80. Additionally, appropriate shortened citation forms are substituted for redundant full citation forms as part of the grammatical processing. Preferably, the text of the authoritative statements, as initially specified by the research set, is maintained through grammatical processing as part of the generated document 82. Grammatic revisions of the assertions and shortened forms of citations are added to the generated document 82 as versioned text nominally superceding the corresponding unmodified authoritative statements.

A generated document 82 is nominally displayed through the user input and display module 72 using a conventional viewer or through a separate presentation or word processing application program supporting the format of the generated document 82. Particularly where displayed using a word processor application, the assertion text may be further modified and additional text added based on user interaction 74. Preferably, these changes are recorded in the generated document 82 as further versioned text. While an unmodified generated document 82 could be regenerated from the research set directly, maintaining versioned changes in the generated document 82 allows regeneration from a combination of the research set and generated document 82, allowing the research set to be iteratively modified, yet appropriately preserving independent modifications made to the generated document 82 directly. To support regeneration, the composition engine 80 preferably correlates the generated document 82 with the research set, which is itself versioned to maintain a record of modifications made through the presentation engine 78. Once a baseline correlation is established, the further changes to the research set can be reconciled against the generated document 82, resulting in the appropriate addition, deletion and reordering of authoritative statements. Grammatical processing is then performed to make consistent the literate presentation of the authoritative statements in combination with added text and, as needed, update and correct citation forms.

A user provided document 84 can be effectively utilized as an initial generated document 82 provided the document contains authoritative statements from which a corresponding research set can be derived. The user provided document 84 is preferably processed through a document processor 86, which substantially performs the functions of the XML document generator 56, citation processor 60, and assertions processor 62. The document processor 86 performs sentence disambiguation, citation detection and expansion, and identification and association of authoritative assertions with citations. The resulting document content is placed in an internal, XML format, prototype document. Finally, the document processor 86 constructs an initial research set based on the sequence of authoritative statements present in the prototype document, validating each authoritative statement against the reference database 58 and functionally establishing the assertions referenced by the research set. The research set can thereafter be modified as desired through operation of the presentation engine 78 and further processed by the composition engine 80 in combination with the prototype document to produce a conforming generated document 82.

In accordance with the present invention, the process of performing research through determination of document result sets, research sets, and generation of documents constitutes a flexible, open, yet fully reentrant methodology. As generally represented in FIG. 5, the research process 90 enabled by the present invention flexibly permits transition between search, analysis and organization, and document generation in user determined order maintained consistent through the selectively shared reference to document result sets, research sets, and research documents. The search subsystem 92 accepts any combination of full text query terms 94, categorical selections 96, and literal bibliographic references 98 to identify document sets that can then be refined through contextual review of the search criteria product and user selection of perceived relevant documents into one or more document result sets 100. Preferably, identifiers of user selected documents are stored together as a document result set 100 either temporarily or as a named document result set in a persistent set storage database 102. Document result sets 100 can be subsequently revisited and, under user direction, revised to include additional documents determined through subsequent searches 92 and exclude other documents.

Typically based initially on a current unnamed or chosen named document result set 100, the included set of authoritative statements are then navigable through a number of different views of the relationships between the authoritative assertions, the correspondence between the authoritative assertions and applicable ontological categories, and the presentation of the authoritative assertions in document context. From the analysis facilitated by user directed navigation through the various views, authoritative statements are selected and organized into one or more research sets 106. Preferably, the scope of a research set 106 can be determined by a user to variously correspond to a particular research issue, a more broadly delineated research topic, or an entire set of matters intended to be addressed in a subsequently generated research document. Research sets 106 can be accumulated as a reference library resource reflecting perspective analysis of many issues and topics. Individual and collections of research sets 106 can be discretely distributed, potentially as objects of commerce.

Individual research sets 106 are preferably stored, by name and with a unique identifier, in the set storage database 102. In the operation of the navigation subsystem 104, research sets 106 can be retrieved and re-presented as navigable views, permitting the addition and deletion of authoritative assertions and the reorganization of the authoritative assertions referenced by a particular research set 106. In the preferred embodiments of the present invention, operational methods are provided to selectively merge and divide research sets 106.

The report generation subsystem 108 preferably operates to generate a research document 110 representing, by order and content, one or more named research sets 106. Each research document 110, as named and stored in the set storage database 102, preferably includes a unique research document identifier and further includes references to the unique identifiers of the corresponding named research sets 106. Also included is the full text of the authoritative statements referenced by the included research sets 106 preferably as processed for literate presentation of the included authoritative assertions and citations.

Generated research documents 110 can also be presented by the report generation subsystem 108 for modification 112, preferably by a wordprocessor application capable of operating natively on an XML structured document with modifications being introduced as versioned edits. Alternately, modifications 112 may be made using a wordprocessor having suitable document conversion filters that permits versioned modifications to be made to research documents 110. Preferably, the XML structure of the research documents 110 is open, thereby enabling third-party wordprocessors to be used to modify 112 research documents 110 without loss of information or functionality relative to other aspects of the research process 90. In addition, modifications made to research documents 110 may be used to introduce modifications to the corresponding research sets 106. By modification, an authoritative assertion, citation, or full authoritative statement may be introduced or removed from a research document 110. Removal can be detected by differencing between the current and prior versions of the modified research document 110. To distinguish from ordinary text modifications, additions of authoritative statements, in whole or part, can be either expressly flagged by the editor, such as by an XML marker or occurrence of a predefined null form citation, or inferenced from a similarity matching between the added phrases and the index of authoritative assertions stored by the reference database 58. Such changes are reflected as versioned modifications into the corresponding research sets 106, which can then be presented as a basis for confirmation, further navigation, selection, and reorganization 104 of the affected research sets 106. In turn, these further changes to the research sets 106 are applied, by operation of the report generation subsystem 108, as a next versioned modification of the research document 110.

Final, published documents 114 are produced by the report generation subsystem 108 from named research documents 110. Preferably, only the last versioned information contained in a research document 110 is included in the published document 114. The published document is also preferably converted, based on a user selection, to a desired output format, such as Postscript, Portable Document Format, or other presentation or wordprocessing format. Optionally, the unique research document identifier is left encoded in the published document 114.

Previously published final documents 114 or conventionally generated third-party documents 116 can be assimilated into the research process 90. Such documents 114, 116 are preferably parsed 118 first to obtain any unique research document identifier that may be present in the document. Where found, or alternately where manually established, the document 114, 116 is presumed to be a later version document corresponding to the named research document 110 having the matching document identifier. The document 114, 116 is then further parsed 118 to functionally add the current version modifications to the existing, matched named research document 110. Thus, the present invention supports reentrant handling of published final documents without external, published exposure or loss of established prior research information.

Third-party documents 116 not matched to a named research document 110 are parsed 118 and processed to directly generate a new research document 110. While no prior version information may exist, this generated research document 110 can be fully populated with the content of the third-party document 116, named and stored to the set storage database 102. A corresponding research set 106, containing the authoritative statements included in the research document 110, can then be generated, named and stored to the set storage database 102. In turn, the generated research set 106 can be used as a basis for the navigation and analysis of the third-party document 116, which is, in particular, useful for evaluating the propriety of the presented authoritative assertions relative to the associated citations, identifying antedated citations, and potentially recognizing issues not treated or that may not be relevant to the topic addressed. User navigation directed revision of the generated research set 106, further reflected through to the generated research document 110 by the report generation subsystem 108, and direct user modification 112 of the research document 110 is fully supported.

The search and presentation subsystems 120 of the present invention are shown in further detail in FIG. 6. User interaction 74 through the input and display module 72 provides search terms, bibliographic references, and ontology selections to the search engine 76 collected as search sets against particular executions of the search engine 76. A history of the search sets, including contents, are stored by a set selection module 122 to a set storage database 124 preferably implemented logically as a portion of the reference database 58 though stored, as specified by user interaction 74, to one of the local, site specific, or global data stores 48, 44, 42, 42′ and subject to corresponding user privileges. Unnamed search sets can be referenced and reused during the current research session while search sets assigned a name through user interaction 74 are persistently stored and accessible across research sessions. Each search set, as made or modified, is also provided to the presentation engine 78, which generates and displays 126 corresponding current and list views 130 of the available named and unnamed search sets. These views 130 support user interaction 74 based modification and further selection of search sets for the execution of searches.

Document result sets 100 are user specified containers of documents identified from one or more search executions. Documents from search result sets are selected through user interaction 74 and assigned to a named, persistent document result set 100 or an unnamed temporary document result set 100, which thereafter may be named. As document selections are made, the affected document result sets 100 are updated to the set storage database 124. The document result sets 100 are also provided to the presentation engine 78 for display 126 in various views 128 to support user interaction 74 based selection of documents and document result sets 100.

Research sets 106 and, similarly, research documents 110, are both containers of authoritative statements. Authoritative statements are typically selected from documents or document derivative views generated by the presentation engine 78 and assigned to specific research sets 106. Research documents 110 are usually generated from and thereby nominally contain the specific authoritative statements of particular research sets 106. While additional and alternate text, including text potentially modifying and providing additional authoritative statements, can be applied directly to research documents 110 from user and external sources, any substantive modifications to the authoritative statements are automatically reflected on as modifications to the corresponding research sets 106. Both named and unnamed research sets 106 and research documents 110 are stored by the set storage database 124 and presented in views 128 to support user interaction 74.

In the preferred embodiments of the present invention, the presentation engine 78 is used to concurrently generate multiple representative data views 128, including graphical, list, contextual, and others, as determined in response to user interaction 74, to support user evaluation of documents, assertions and citations. The input and presentation display module 72 enables user navigation of the displayed data to enable specification of further views 128 to be displayed 126 and, further, the user directed selection and organization of query terms, documents and authoritative statements in the search, document result, research and research document sets. The preferred views 128 displayable in regard to search operations are listed in Table V.

TABLE V
Search Related Views

| View | Content | Primary Action Supported |
|---|---|---|
| ontology list | window providing a hierarchical list or tree related presentation of | document and search term selection |
| | the categories representing the document collection | |
| | ontology | |
| search term set | search specification window supporting entry and revision of a set | entry/edit of query term search set |
| | of search terms (literal bibliographic references are treated | |
| | as single search terms) | |
| search term history | window providing a list or tree organized identification of the | search term set selection |
| | search term sets used for executed searches | |
| search results list | window presenting an ordered list of the documents selected and | document selection |
| | returned as the results of a search set execution | |
| document result set | window presenting an ordered list of the documents collected in a | document selection |
| | document result set | |
| document result sets list | window presenting a list of the currently available unnamed | document result set selection |
| | (temporary) and named (persistently stored) document | |
| | result sets | |
| source document - context | pop-ups or window that displays an abbreviated, context | document selection |
| | dependent section of the selected source document; | |
| | triggerable from a document listed in a search results list or | |
| | a document result set to open a window providing a | |
| | scrollable, search term in context abbreviated view of the | |
| | document | |
| source document - full | window that displays a source document; triggerable from a | document selection |
| | document listed in a search results list or a document result | |
| | set to open a window providing a scrollable, search term in | |
| | context abbreviated view of the document | |

The preferred views 128 displayable in regard to analysis and organization operations are listed in Table VI.

TABLE VI
Analysis and Organization Related Views

| View | Content | Primary Action Supported |
|---|---|---|
| research set | window presenting the ordered list of authoritative statements that | statement selection, organization |
| | have been collected into a research set; editable primarily | |
| | to add, delete, and reorder the list of authoritative | |
| | statements | |
| research sets list | window presenting a list of current unnamed (temporary) and | research set selection |
| | named (persistently stored) research sets | |
| research document | window presenting the literately processed block of text and | statement selection, organization |
| | authoritative statements as compiled into a research | |
| | document; editable directly primarily to adjust literate | |
| | presentation, though text and authoritative statements can | |
| | be added, deleted, and reordered | |
| research document list | window presenting a list of the current unnamed (temporary) and | research document selection |
| | named (persistently stored) document result sets | |
| assertion cluster graph | graph displaying the correlated relationships between assertions | assertion selection |
| | associated with a particular citation; permits user selection | |
| | of a particular, desired assertion form; supports node pop- | |
| | ups to show assertions in context and, therefrom, selection | |
| | of related assertion clusters for view | |
| citation relationship graph | graph displaying the correlated relationships between assertion | statement selection |
| | clusters and/or particular citations and/or authoritative | |
| | statements; supports node pop-ups to show normalized | |
| | assertions in context and, therefrom, specific assertions and | |
| | selection of related assertion clusters for view | |
| source document - context | pop-up or window that displays a section of a source document to | statement selection |
| | show an assertion in context; triggerable from a graph | |
| | node or an assertion in a research set or a research | |
| | document to open a window providing a scrollable, | |
| | abbreviated view of the assertion in the context of a source | |
| | document | |
| source document - full | window that displays a source document; triggerable from a | statement selection |
| | graph node or an assertion in a research set or a research | |
| | document to open a window providing a scrollable view of | |
| | the source document | |

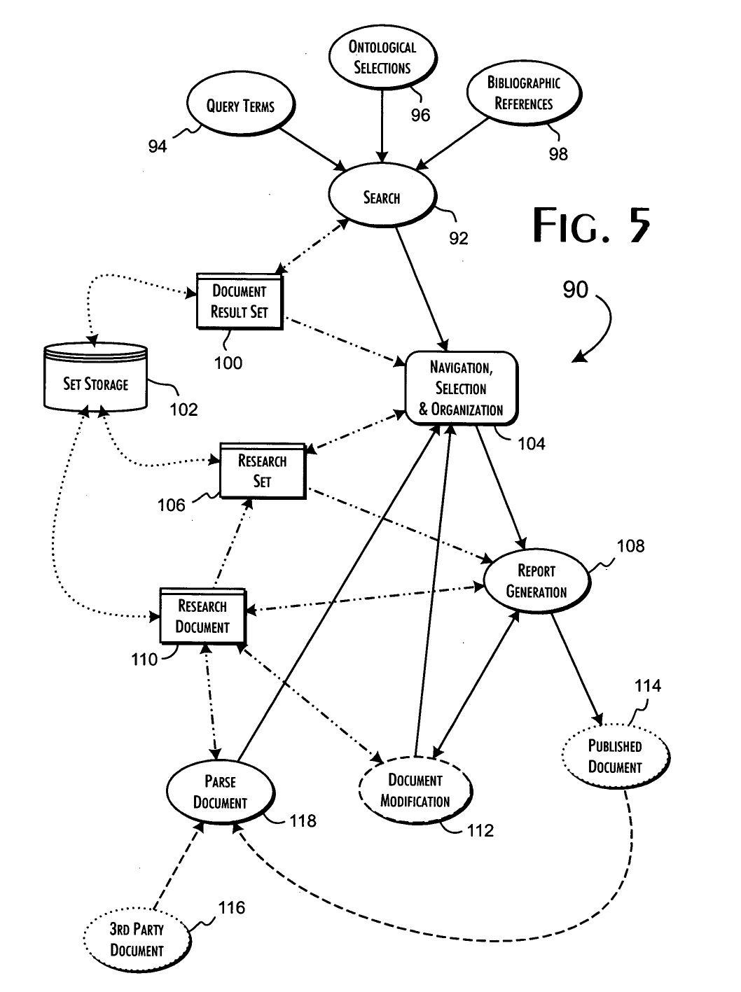

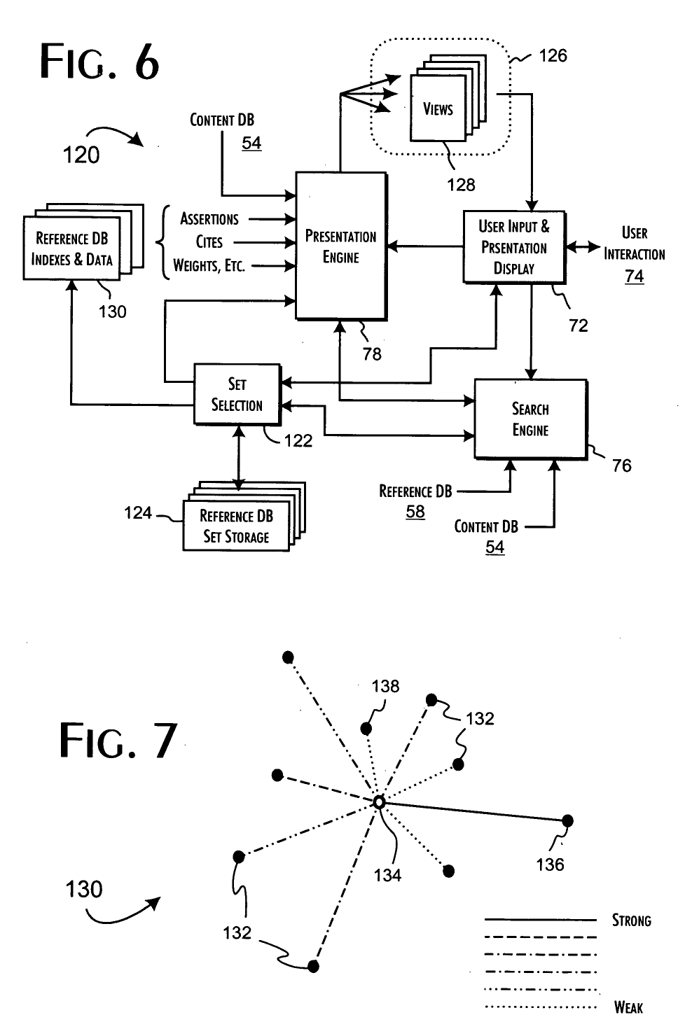

The analysis and organization related views 128 include views that selectively present the source content 52 as stored by the content database 54 and the preprocess data 130 as stored and indexed in the reference database 58. Preferably, various graph and mesh based views are provided to display the cluster, reference, and co-occurrence associative relationships between assertions relative to a chosen assertion, citation, or assertion cluster. The form 130 of a preferred assertion cluster view is shown in FIG. 7. The assertion cluster is defined against a single citation or a set of equivalent citations, which differ, for example, by reference to parallel journals or reporters. Nodes 132 each represent a distinct assertion or set of assertions within a closely defined range of similarity. The nodes 132 are arrayed to graphically represent mutual similarity by radial ordering and by relative distance from the preprocess determined normalized form 134 of the assertion. Gradations of strong 136 to weak 138 links, drawn preferably between the nodes 132 and normalized form 134, are used to graphically represent the relative frequency of occurrence of the individual assertions. Other graphical annotations can be represented through other attributes, such as arrows and color, to display features such as the time order of document publication, the citing journal or jurisdiction, and the strength of association to another assertion cluster, determined as the degree of similarly between closely similar normalized assertions associated with different citations.

The assertion cluster view 130 supports user directed navigation to facilitate contextual analysis of the various assertion forms. Selection of a node 132, based on user interaction 74, enables, for example, exploration of the context of the assertion as it occurs in documents, expansion of a node cluster of closely similar assertions into an assertion cluster view of the individual assertions, and creation of a new citation relationship view showing the occurrence of a particular assertion in relation to other correlated authoritative statements. Selection of an assertion also enables the user directed addition of the corresponding authoritative statement to any chosen research set.

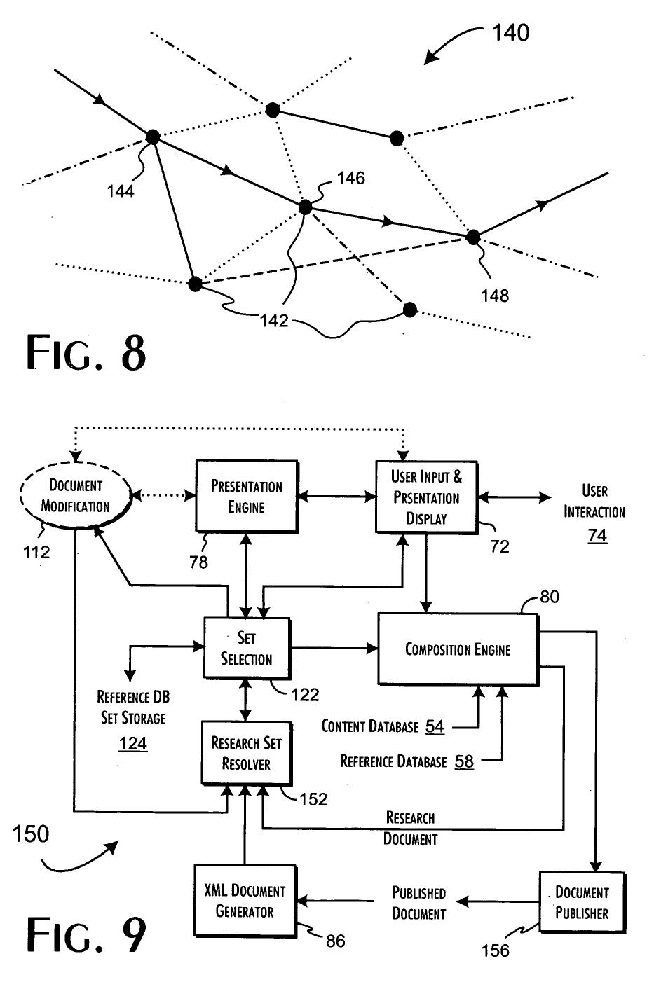

The preferred form 140 of reference and co-occurrence views as mesh graphs are similar, generally as shown in FIG. 8, and, further, may be displayed in the same view. The nodes 142 represent any combination of individual authoritative assertions and assertion clusters. The mesh display of the nodes 142 can represent the successive reference associations between assertions, as suggested by the progression of nodes 144, 146, 148. The interconnects of the mesh of nodes 142 can also be calculated to represent the relative order and, by distance, the mutual affinity of the authoritative statements. As in the cluster view 130, gradations of strong to weak links extending between the nodes provide a graphical representation of the weighted frequency of mutually ordered occurrence among the nodes 142. Thus, with the graph centered for analysis on node 146, a highly ordered correlation is readily evident between the authoritative assertions represented by the nodes 144, 146, 148, as well as with respect to the other nodes 142. As with the assertion cluster view 130, annotations can be represented as graphical attributes to distinguish, for example, the citing journal or jurisdiction and whether an authoritative statement is cited as supporting a contested, overturned or minority position.

Navigation of the mesh 140 is preferably performed by selecting any of the visible nodes 142 as the new center of the mesh. Nodes within threshold limits set by distance and affinity parameters through by user interaction 74 are selected by evaluation of the reference database 58 indexes and data 130 and drawn to the same or additional view 128. Individual nodes 142 can be explored by user selection to drill-down into clusters and pop-up contextual and other text views specific to the node authoritative statement. From these, further views can be specified by user interaction 74, including expanding a cluster of correlated authoritative statements to a citation relationship view of the individual authoritative statements, branching an additional citation relationship view from an existing view to permit independent navigation of the mesh 140, creating an assertion cluster view for a selected authoritative statement, and displaying a full list of the authoritative statements present in a document containing an authoritative statement selected from the mesh 140. By each of these views, user analysis of the information presented is facilitated and, from each of these views, selection of authoritative statements by user interaction 74 enables addition of the selected authoritative statements to a chosen research set 106.

The document composition subsystem 150 is shown in further detail in FIG. 9. Preferably, based on a mode selection made by user interaction 74, the composition subsystem 150 is operated to generate a research document 110 from a specified research set 106, regenerate a research document 110 based on a modified research set 106, update a research set 106 based on a modified research document 110, produce a published final document 114 based on a specified version of a selected research document 110, and import an external document 114, 116 and produce or update corresponding research documents 110 and research sets 106. The composition engine 80 operates from an existing research set 106 or research document 110 specified by user interaction 74 and retrieved through the set selector 122 from the set storage database 124. The research document 110 then generated or selected and reprocessed by the composition engine 80 is provided to a research set resolver 152 that controls storage of the resultant research document 110 back to the set storage database 124. Preferably, the research document 110 is stored in association with the research set 106 identified by the unique research set identifier established in the research document 110.

To support versioning of both the research set 106 and research document 110, potentially allowing multiple research documents 110 to be associated with a single research set, the generation of a research document 110 is preferably specified against a particular version of a research set 106 or other research document 110. The research set resolver 152 provides for the concurrent storage of research documents 110 descended from different versions of research sets 106 and research documents 110. Identity between a research set version and a research document 110 is maintained by annotating the research set identifier, as incorporated in a research document 110, with a version identifier.

Research documents 110 can be retrieved from the set storage database 124 for user directed modification 112 using a conventional word processor application or a local editor provided as an adjunct to the presentation engine 78 and input and display module 72. Modified research documents 110 are preferably saved back to the set storage database 124 through the research set resolver 152. Where authoritative statements are added, reordered, or deleted, by user directed modification 112, conforming changes, through versioning, are made to the corresponding research set 106. The modified research document 110 can then be reprocessed through the composition engine 80 to check, correct, and conform the text of the research document, particularly including adjustment of citation forms for literate presentation.

A research document 110 is published to a final document 114 form by passing or reprocessing the research document 110 through the composition engine 80 to provide a user specified version of the research document 110 to a document publisher 156. This version limited text is then further filtered to a user selected electronic document format for delivery typically to a third party.

Published documents, including independent third party generated documents 116 and derivative versions of published final documents 114, are imported by processing the documents through the XML document generator 86 to produce a new or updated research document 110. This imported research document is provided to the research set resolver 152 for matching with a research set 106. The research set resolver 152 preferably uses the embedded research set identifier, if retained in a published document, or a best match of the ordered authoritative statements contained in the imported research document against the existing research sets 106. Where a match is made, and preferably confirmed by use interaction 74, the imported research set 106 is stored to the set storage database 124 in association with the matched research set 106. Further matching against the existing research documents 110 associated with the matched research set 106 may permit the imported research set 106 to be identified and incorporated as a subsequent, reentrant version of an existing research document 110, thereby permitting preservation of at least the locally available modification history of the imported research document 110.

Where no match is made or accepted, a new research set 106 is derived from the imported research document 110 and both are stored to the set storage database 124. The imported research document 110 is then freely available for user directed document modification 112 and subsequent publication 156. Additionally, the derived research set 106 is equally available for user directed analysis, modification, and reorganization through operation of the presentation engine 78. In accordance with a preferred embodiment of the present invention, selected attributes presented in selected views 128 of a selected research set 106 can be generated by the presentation engine 78 in response to user interaction 74. These display or otherwise annotative attributes reflect and identify checks made by the presentation engine 78 to verify, validate, and determine exceptions in a research set 106. The automated verification analysis checks each authoritative statement to determine whether any newer citation exists within the document collection. Optionally, verification analysis identifies whether there exists other and more frequently referenced citations for the given authoritative assertion.

The automated validation analysis determines whether the assertion presented in an authoritative statement corresponds to the given citation. Preferably, the assertion is matched for sufficient similarity to the cluster of assertions associated with the citation. Failure to find a threshold level of similarity determined relative to the cluster distribution of assertions, a flogging attribute is associated with the authoritative statement to prompt further user analysis. Otherwise, a relative similarity attribute is associated with the assertion, which also permits consideration through user analysis.

Exception analysis is preferably performed in connection with the citation relationships view 140 where potential omissions in authoritative statements of a research set 106 can be most clearly displayed in a view 128. The graphical display of a research set 106, subject to exception analysis by the presentation engine 78, presents an overlay of the included authoritative statements against the citation relationships network determined from the preprocessing of the document collection. Instances where, for example relative to FIG. 8, a research set 106 includes authoritative statements corresponding to disjunct nodes 144, 148, the preferably attributed display of an intervening node 146 directly prompts further user analysis.

Thus, a system and methods for performing user directed research over complex document collections containing authoritative knowledge has been described. While the present invention has been described particularly with reference to legal and scientific document collections, the present invention is applicable to any information system internally consistent authoritative references, including those that use semantic characterization of citation references.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A computer system enabling user directed information research against an authoritatively organized document collection, said computer system comprising:
a) a database storing first data identifying a set of authoritative statements present within the documents of said predetermined authoritative document collection, second data specifying the locations of the authoritative assertions of said set of authoritative assertions within the documents of said predetermined authoritative document collection, third data specifying correlated associations between the authoritative assertions of said set of authoritative assertions within the documents of said predetermined authoritative document collection; and
b) a processor, coupleable to said database, operative to generate a mesh representational view of the correlated associations between the authoritative assertions of said set of authoritative assertions and wherein said processor is responsive to user input for navigation through said mesh representational view and user determined selection of a subset of said set of authoritative assertions.

2. The computer system of claim 1 wherein said third data defines relative distance weighted, directional associations between the authoritative assertions of said set of authoritative assertions within the documents of said predetermined authoritative document collection.

3. The computer system of claim 2 wherein the authoritative assertions of said set of authoritative assertions are representable as nodes within said mesh representational view and wherein said third data determines the relative interconnection of said nodes within said mesh representational view.

4. The computer system of claim 3 wherein said database further stores fourth data identifying authoritative citations in correspondence with the authoritative assertions of said set of authoritative assertions, wherein selection of said subset includes selection of the corresponding authoritative citations, said processor being further operative to generate a literate report of said subset of said set of authoritative assertions and corresponding authoritative citations.

5. The computer system of claim 4 wherein generation of said literate report includes syntactic processing of said subset of said set of authoritative assertions.

6. The computer system of claim 5 wherein generation of said literate report includes reformation of said corresponding authoritative citations dependent on the order of occurrence of said corresponding authoritative citations within said literate report.

7. The computer system of claim 6 wherein generation of said literate report includes maintenance of predetermined report content provided in response to user input relative to said subset of said set of authoritative assertions and corresponding inclusion of said predetermined report content in said literate report.

8. The computer system of claim 7 wherein said processor is operative to maintain source versions of said subset of said set of authoritative assertions, said corresponding authoritative citations, and said predetermined report content for reference in connection with the syntactic processing of said subset of said set of authoritative assertions, including said predetermined report content, and the reformation of said corresponding authoritative citations.

9. A method of performing information research against an authoritatively organized document collection, wherein the method is supported by a computer-implemented framework operating against a computer accessible database representation of the authoritatively organized document collection, said method comprising the steps of:
identifying, in response to user input, a selected authoritative assertion occurring within a selected document of a predetermined document collection containing authoritatively organized information;
associating a plurality authoritative assertions, which occur within the documents of said predetermined document collection, with said selected authoritative assertion based on weighted relationships derived from the relative mutual occurrence of said selected and plurality of authoritative assertions within the documents of said predetermined document collection;
generating a representational view of said plurality of authoritative assertions organized to reflect said weighted relationships, wherein said representational view enables user directed navigation over said plurality of said authoritative assertions;
selecting, in connection with said user directed navigation, a subset of said plurality of authoritative assertions, wherein the authoritative assertions of said subset are provided in a determined order; and
preparing a literate report incorporating said subset in said determined order.

10. The method of claim 9 wherein said step of preparing provides for the syntactic processing of said subset to improve the literate presentation of the authoritative assertions of said subset in said determined order.

11. The method of claim 10 wherein authoritative citations exist in correspondence with the authoritative assertions, wherein said step of preparing includes incorporating a predetermined set of authoritative citations, corresponding to the authoritative assertions of said subset, into said literate report.

12. The method of claim 11 wherein said step of preparing further provides for the reformation processing of said predetermined set of authoritative citations to improve the literate presentation of said predetermined set of authoritative citations in said literate report relative to said determined order.

13. The method of claim 9 wherein said step of associating a plurality authoritative assertions includes the steps of:
a) determining a first authoritative citation associated with a first authoritative assertion; and
b) locating a second authoritative assertion that is referenced by said first authoritative citation and semantically correlated with said first authoritative assertion.

14. The method of claim 13 wherein said step of locating said second authoritative assertion includes the step of comparing a semantic similarity metric computed for said first authoritative assertion with semantic similarity metrics computed for each of the authoritative assertions referenced by said first authoritative citation to distinguish said second authoritative assertion.

15. The method of claim 13 wherein said step of locating said second authoritative assertion includes the step of comparing a semantic similarity metric computed with respect to said first authoritative citation with semantic similarity metrics computed for each of the authoritative assertions referenced by said first authoritative citation to distinguish said second authoritative assertion.

16. The method of claim 9 wherein said step of generating said representational view includes the steps of:
a) first determining as said weighted relationships a set of relative distance weighted, directional associations describing the mutual associativity of the authoritative assertions within said plurality of authoritative assertions; and
b) second determining an attributed representation of said set of relative distance weighted, directional associations as a mesh interconnecting nodes representing said plurality of authoritative assertions as said representational view.

17. The method of claim 16 wherein authoritative assertions have corresponding authoritative citations and wherein said step of first determining provides said set of relative distance weighted, directional associations relative to authoritative assertions having different corresponding authoritative citations.

18. The method of claim 17 wherein said step of first determining further provides said set of relative distance weighted, directional associations relative to authoritative assertions having the same corresponding authoritative citations.

19. The method of claim 18 wherein said step of second determining selectively provides said mesh based on said set of relative distance weighted, directional associations relative to authoritative assertions having different corresponding authoritative citations and relative to authoritative assertions having the same corresponding authoritative citations.

20. A computer system providing a framework for information research over an authoritatively organized document collection containing authoritative statements including authoritative assertions coupled with authoritative citations, said computer system comprising:
a) a computer database storing reference data derived from said document collection associating the mutual relative occurrence of said authoritative assertions occurring within the documents of said document collection, said reference data further associating first authoritative assertions through first authoritative citations to second authoritative assertions, wherein said second authoritative assertions are disambiguated relative to said first authoritative citations by a predetermined metric of semantic similarity; and
b) a processor coupleable to said computer database implementing a first framework module operable to display a representation of said reference data, a second framework module operable to enable user selection of a research set of authoritative assertions, and a third framework module operable to generate a report of said research set of authoritative assertions.

21. The computer system of claim 20 wherein said reference data includes weight values reflecting the mutual relative distance of occurrence of said authoritative assertions occurring within the documents of said document collection and wherein said weight values determine the default ordering of said authoritative assertions in said research set.

22. The computer system of claim 21 wherein said weight values further reflect a cluster association of a predetermined authoritative assertion relative to a predetermined authoritative citation.

23. The computer system of claim 22 wherein said representation produced by said first framework module is a mesh representation of a selected subset of said reference data and wherein said selected subset is determined by user directed navigation of said mesh representation.

24. The computer system of claim 23 wherein user selection of said research set is determined in conjunction with user directed navigation of said mesh representation.

25. The computer system of claim 24 wherein said third framework module is operative to grammatically process said research set of authoritative assertions to provide said report as a literate report.

26. A computer-based system for developing a compilation of authoritative knowledge, said computer-based system comprising:
a) a first database of authoritative knowledge including a plurality of authoritative statements;
b) a second database of weight values interrelating said plurality of authoritative statements;
c) a viewer, coupled to said first and second databases, enabling presentation of a subset of said plurality of authoritative statements including a set of identified authoritative statements and a set of supplemental authoritative statements, wherein said set of supplemental authoritative statements is selected based on associations determined from said second database of weight values and relative to said set of identified authoritative statements;
d) first controls, coupled to said viewer, operative to influence the selection of said set of supplemental authoritative statements; and
e) second controls, coupled to said viewer, operative to produce a report of said set of identified authoritative statements.

27. The computer-based system of claim 26 wherein said first controls are operative to include authoritative statements of said set of supplemental authoritative statements in said set of identified authoritative statements.

28. The computer-based system of claim 27 further comprising a parser operative on said report to initially determine said set of identified authoritative statements.

29. The computer-based system of claim 28 wherein said report is a literate report of said set of identified authoritative statements.

30. An apparatus for processing a document collection to enable authoritative information research, said apparatus comprising:
a) a database that provides for the storage of data with respect to a set of authoritative assertions occurring within the documents of a predetermined document collection; and
b) a processor coupleable to access the documents of said predetermined document collection and further coupleable to store first and second data to said database, said processor being operative to generate first data identifying said set of authoritative assertions, said first data further identifying the locations of said set of authoritative assertions within the documents of a predetermined document collection, said processor being further operative to generate second data containing a weighted correlation of the mutual relative occurrence of the authoritative assertions of said set of authoritative assertions within the documents of said predetermined document collection, and wherein said processor provides for the storage of said first and second data in said database,
whereby said first and second data provides an authoritatively related basis for analyzing the documents of said predetermined document collection.

31. The apparatus of claim 30 wherein said second data further contains weighted correlations representing semantic similarity of the authoritative assertions of said set of authoritative assertions.

32. The apparatus of claim 31 wherein said first and second data defines a weighted correlation mesh interrelating the authoritative assertions of said set of authoritative assertions.

33. The apparatus of claim 32 wherein said weighted correlations include directional information reflecting the ordered of occurrence of the authoritative assertions of said set of authoritative assertions within the documents of said predetermined document collection such that said first and second data defines a directionally weighted correlation mesh
whereby said first and second data provides a directed basis for analyzing the ordered occurrence of conceptual issues represented by sequences of authoritative assertions occurring within said set of authoritative assertions.

34. The apparatus of claim 33 wherein said second data, as generated by said processor, correlates first and second predetermined authoritative assertions by a weighted ordered distance metric derived by analysis of the mutual relative locations of said first and second predetermined authoritative assertions within documents of co-occurrence of said predetermined document collection.

35. The apparatus of claim 34 wherein said processor, in generating said second data, computes a semantic affinity metric for the authoritative assertions of said set of authoritative assertion as a basis for establishing conceptual content associations between the authoritative assertions of said set of authoritative assertions.

36. The apparatus of claim 35 wherein said second data, as generated by said processor, includes cluster association information for the authoritative assertions of said set of authoritative assertions, wherein said cluster association information is determined based on said semantic affinity metric as computed for each of the authoritative assertions within said set of authoritative assertions.

37. A method of preparing a document collection research database to support information analysis and reporting, said method comprising the steps of:
a) processing the documents of a predetermined authoritative document collection to locate authoritative assertions;
b) determining weighted correlations of the mutual occurrence of authoritative assertions in the documents of said predetermined document collection; and
c) storing reference data to a research database including references to said located authoritative assertions and said weighted correlations, wherein said weighted correlations are stored in a defined correspondence with said located authoritative assertions,
whereby the weighted correlations between authoritative assertions provide an associative basis for analyzing the informational content of said predetermined authoritative document collection.

38. The method of claim 37 wherein said weighted correlations reflect the ordered occurrence of mutually associated authoritative assertions within the documents of said predetermined document collection.

39. The method of claim 38 wherein first authoritative assertions are coupled with authoritative citations and wherein said weighted correlations reflects the association of said first authoritative assertions by reference through authoritative citations to second authoritative assertions.

40. The method of claim 39 further comprising the step of identifying, for a predetermined first authoritative assertion, a predetermined said second authoritative assertion based on said authoritative citation coupled with said predetermined first authoritative assertion and a semantic affinity metric computed for said predetermined first and second authoritative assertions.

41. The method of claim 40 wherein said weighted correlations reflects the affinity of the said authoritative assertions to semantically affine clusters of authoritative assertions, the weighted ordered distance between authoritative assertions within a first predetermined limit, and the semantic affinity and ordered distance between said clusters within a second predetermined limit.

42. A method of disambiguating authoritative citations establishing references to documents within an authoritative document collection to support a process of authoritative information analysis, wherein said method is autonomously performed by a computer system having access to the documents of said authoritative document collection, said method comprising the steps of:
a) identifying, within a first document of a document collection, a first authoritative assertion associated with a first authoritative citation;
b) determining, within a second document of said document collection specified by said first authoritative citation, a set of authoritative assertions; and
c) selecting a second authoritative assertion from said set of authoritative assertions based on a semantic similarity metric computed for said first authoritative assertion and each authoritative assertion of said set of authoritative assertions, said second authoritative assertion having a greater semantic correlation to said first authoritative assertion.

43. The method of claim 42 further comprising the step of constructing a reference database storing data representative of the association of said first and second authoritative assertions.
